(19) United States
(12) Patent Application Publication
(10) Pub. No.: US 2001/0042060 A1
(43) Pub. Date: Nov. 15, 2001

(54) Attribute tagging and matching system and method for database management

(75) Inventors: Rolly Rouse, Newton, MA (US); Shawn Becker, Newton, MA (US)

Correspondence Address: PERKINS, SMITH & COHEN LLP, ONE BEACON STREET, 30TH FLOOR, BOSTON, MA, 02108, US

(73) Assignee: HomePortfolio Inc. a Massachusetts corporation, Newton, MA (US)

(21) Appl. No.: 09/789,395

(22) Filed: Feb. 20, 2001

Related U.S. Application Data
(60) Provisional application No. 60/183,709, filed on Feb. 18, 2000.

(51) Int. Cl. G06F 7/00

(52) U.S. Cl. 707/1; 707/104.1

(57) ABSTRACT

An attribute language and attribute tagging and matching system is used to permit fine-grained data searches based on overall similarity using attribute values and weightings. The searches use similarity to specific attributes, or similarity to combinations of attributes. The system includes an attribute language and a structure for inputting attribute values. It includes “relevance” weightings that are used to refine calculations of the similarity between specific products. These weightings substantially increase the precision of search results and the usefulness of the order in which search results are presented. The invention further includes a system for tuning search results. This system includes the application of “must match” checkboxes to particular attributes, coupled with “importance” weightings applied to any or all attributes, including those that are not checked as “must match.”

### CROSS-REFERENCE TO RELATED APPLICATIONS

This application claims priority of U.S. provisional applications Ser. No. 60/183,709 entitled, “Attribute Tagging and Matching System and Method for Database Management” filed Feb. 18, 2000 by the present applicant.

### FIELD OF THE INVENTION

This invention relates generally to computer databases and more particularly to searching and retrieving data from a database using attribute tags and weights.

### BACKGROUND OF THE INVENTION

With the improvements in computer capabilities, there has been an exponential increase in data stored in databases. Once stored, data needs to be accessible, preferably quickly and to a fine degree of granularity. The vast amounts of data stored in databases drives a need for easy-to-navigate databases and for efficient and specific data retrieval. The explosive growth of commerce, both consumer and business-to-business, on the Internet has linked many commercial databases of diverse structure and content.

Effective searching is a particular problem if the data items are image-based or based on some other type of data object rather than character-based (that is, words or numbers). Alphanumeric character-based data allows string searches. Images, or other data objects, by themselves are generally not searchable by data string search or the like. Such data objects as pictorial works or representations of real-world physical objects are indexed, if at all, in diverse ways that do not lend themselves to searches over large aggregates of such data objects or distributed databases.

It remains desirable to have a system and method for searching databases effectively, particularly a database storing noncharacter-based data objects.

It is an object of the present invention to provide a method and apparatus using an indexing system of attributes assigned subjective weights to search an image-based database easily and efficiently.

It is another object of the present invention to provide a method and apparatus to enable consumers, retailers, integrators, designers and others to effectively navigate a product database over the Web.

### SUMMARY OF THE INVENTION

The problems of retrieving data objects from a database are solved by the present invention of an attribute tagging and matching system and method for database management.

The present invention has an attribute language and attribute tagging and matching system in which attribute values and weightings are used to permit fine-grained data searches based on overall similarity. Similarity is measured by closeness of matching of specific attribute values or of combinations of attributes. The system includes an attribute language syntax that provides structure for assigning attribute values. It includes “relevance” weightings for values of certain attributes that have multiple values for a particular product; these are used to refine calculations of the similarity between specific products. These relevance weightings substantially increase the precision of search results and the usefulness of the order in which search results are presented.

The invention further includes a system for tuning search results. This system includes the application of “must match” checkboxes to particular attributes, coupled with “importance” (relative to other attributes, different from “relevance” as to a given attribute) weightings applied to any or all attributes, including those that are not checked as “must match.” Search results may be tuned across an entire database category as a default setting, or at the level of a single database entry.

The present invention also enables a user to organize and store data items in a personal database and to make that personal database accessible for data retrieval by others.

The attribute system described herein is applied to a database related to home design. The system, however, is applicable to and valuable for any complex database of images and/or products.

The present invention together with the above and other advantages may best be understood from the following detailed description of the embodiments of the invention illustrated in the drawings, wherein:

### BRIEF DESCRIPTION OF THE DRAWINGS

FIG. 1 is a block diagram of the attribute tagging and matching system according to principles of the invention;

FIG. 2 is a block diagram of a record of an object in the image/product database of FIG. 1;

FIG. 3 is an example of a record of an object using the structure shown in FIG. 2;

FIG. 4 is a screen shot of an introductory screen showing a list of categories according to principles of the invention;

FIG. 5 is a screen shot of the category of bathroom fixtures and fittings selected from the list of FIG. 4;

FIG. 6 is a screen shot of the tubs category selected from the list of FIG. 5;

FIG. 7 is a list of the tubs category resulting from a selection made from the options shown in FIG. 6;

FIG. 8 is a screen shot of a tub item selected from the list of FIG. 7;

FIG. 9 is a list of tubs resulting from a “Find Similar” search on the tub of FIG. 8;

FIG. 10 is a block diagram of a data structure for a “Find Similar” search using the object of FIG. 3;

FIG. 11 is a pair of tables of attributes and values, one table of a source object and one table of a target object in the database;

FIG. 12 is a flow chart of the “Find Similar” process according to principles of the invention; and

FIG. 13 is a diagram demonstrating the use of the “My Portfolio” database according to principles of the invention.

### DETAILED DESCRIPTION OF PREFERRED EMBODIMENTS

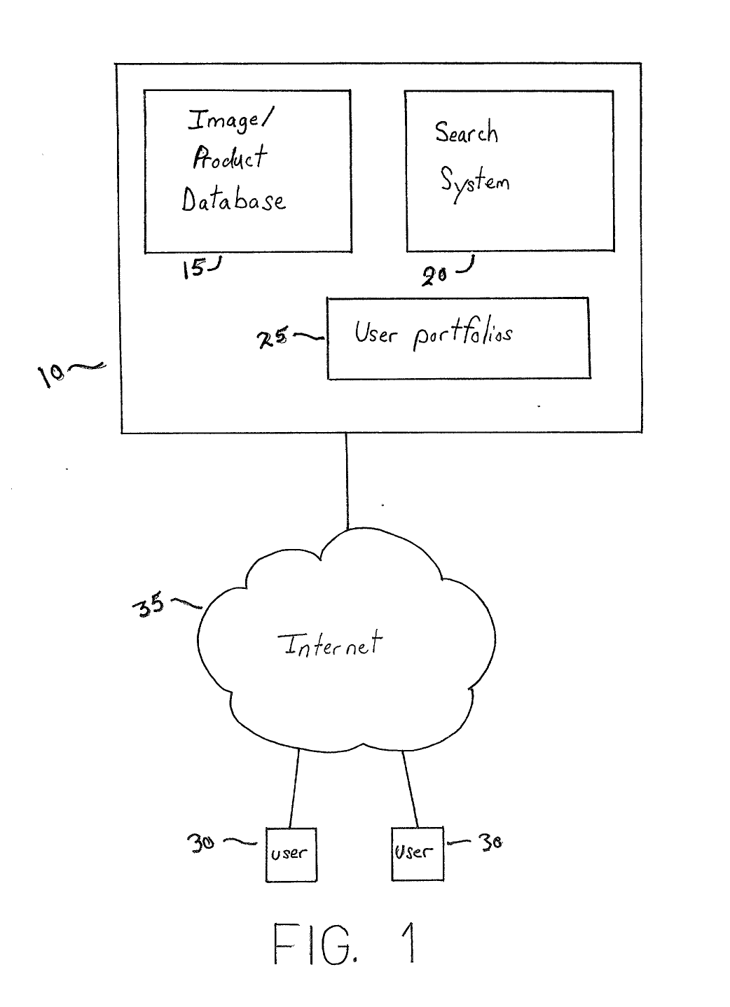

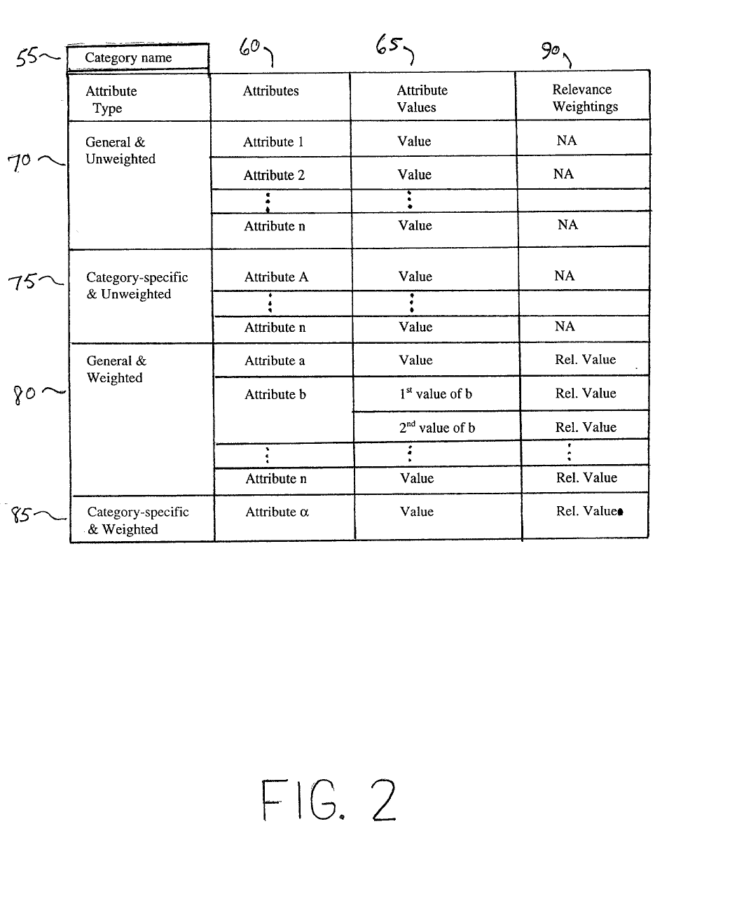

FIG. 1 is a block diagram of the attribute tagging and matching system according to principles of the invention. The system 10 has a database 15, a search system 20 and a user portfolios database 25 available to users 30 over the Internet 35. In the present embodiment of the invention, the database stores product information using a schema that will be described below with regard to FIG. 2. In alternative embodiments of the invention, other data objects may be used such as graphics objects or music objects. The items in the database have associated attributes and tags that the search system uses to navigate the database. Users access the system over the Internet, search the database, create search results, refine search results, and create individual user portfolios in the user portfolios database. In the user portfolios, the user may attach individual user ratings, such as “Love It,” “Like It,” or “Not My Style” to database items in order to individualize searches of the database.

FIG. 2 is a block diagram of a record for an object in the database. Each item in the database belongs to one or more categories 55. Each item also has attributes 60 and associated values 65. There are four attribute types: general and unweighted 70; category-specific and unweighted 75; general and relevance weighted 80; and category-specific and relevance weighted 85. A general attribute applies to a plurality of categories, although not to all categories in the database. A category-specific attribute applies only to a single category. The weighted attributes 80, 85 also have relevance values 90 which will be described below.

Unweighted Attributes

Unweighted attributes 70, 75 are those descriptors that have a true/false quality, that is, either the descriptor applies to the item or it does not. Unweighted attributes are, for example, basic information attributes such as manufacturer, product line, product name, model number, list price and materials. For example, attributes and selected attribute values for a product that is a “dresser” may be as follows:

| | |
|---|---|
| Material = | wood |
| | walnut |
| Finish = | shellac |
| | satin |
| | natural |
| Number of drawers = | six |
| Height = | 72″ |
| Width = | 36″ |
| Depth = | 18″ |
| Leg style = | ball-in-claw |
| Top edge = | bullnose |

These attributes are typically selected using check boxes on a complete attribute list for that category, using pop-up lists, or using scrolling lists. Attributes that are not easily generalized may be input as typed-in text (as for precise dimensions).

Attributes may have multiple values (such as, the material is both wood and walnut, and the finish is simultaneously shellac, satin, and natural).

Certain unweighted attributes are not generic, but rather are category-specific, product-specific, manufacturer- specific or belong to some other type of grouping. These “category-specific” attributes are displayed only when the user of the system is browsing in the specific area where the attribute applies.

Relevance Weighted Attributes

Relevance weighted attributes 80, 85 are those attributes where the descriptor applies to the product to some degree. The value indicating how much or how little the attribute applies is the “relevance” weight assigned to that attribute. Relevance weighted attributes include, for example, the space in which the product appropriately belongs, such as the kitchen, the bath, the family room, the bedroom, the home office, outdoors, the living room, the dining room, the sunroom, the exercise room, the library, the porch, the home theatre, the spa/pool, or the laundry. For each product, each of these room attributes would be assigned a numerical weight, that is, a value that indicates how well the product fits in that room.

In the present embodiment of the invention, the relevance weights are blank at initialization of the products database, and are either left blank or are assigned a five- point weighting on a scale from zero to four. Typically the weightings are assigned using pop-up lists, although in alternative embodiments of the invention, other methods may also be used. Using, for example, the relevance weighted attribute of the space (or room) in which the product appropriately belongs: a value of four means that the product always goes in the attribute room and rarely in another; a value of three means that the product goes well in the attribute room and in other rooms; a value of two means that this product sometimes goes in the attribute room; a value of one means that the product rarely goes in the attribute room; a value of zero means that the product never goes into the attribute room; and a blank means that the attribute is not weighted.

Other scales may be used effectively within the scope of the present invention. Alternative scales include alphabetical scales like A to F and numerical scales using different ranges such as 1 to 10 or −5 to +5). The specific scale may be modified over time and may be further tuned using global and category-specific business rules. Variations include applying different numbers to different weightings in a way that is non-linear, or in a way that converts median weightings into zero values and below-median weightings into negative values.

Other examples of relevance weighted attributes include style attributes. General style attributes include descriptors such as “traditional,” “country,” “rustic,” “hip,” “modern,” “contemporary,” “Arts & Crafts,” “formal,” “casual,” and “romantic.” Further examples of general relevance weighted attributes are attributes that may be recorded and used to affect the order or groupings in which products are presented including image quality, scan quality, overall quality of materials, overall quality of workmanship, overall quality of the product's design, how closely the qualities of a particular product coincide with a particular organization's brand identity, and how much a specific editor, celebrity, or consumer likes a database entry.

Certain relevance weighted attributes are category specific. An example of this is the style attribute of the home exteriors category. The styles include for example, Shingle-Style, Colonial, Cape, Shingle-Style Colonial, Victorian, Queen Anne Victorian, and Bauhaus. As with all other weighted attributes, each of these category-specific style attributes receives a relevance weighting, such as, blank, or 0 to 4 in which 0 means the attribute is not relevant and 4 means the attribute is highly relevant.

The relevance weighted attribute architecture for general and category-specific attributes enables the system to represent numerically the reality that products, collections, scenes, and whole houses are often multiple things, not one thing. For example, a house could be simultaneously Shingle-Style, Colonial, Shingle-Style Colonial, and Victorian.

The numerical weightings further differentiate these individual observations. For example, the relevance weightings might be as follows: Shingle-Style (4), Colonial (2), Shingle-Style Colonial (3), Victorian (2), Queen Anne Victorian (1), and Bauhaus (0).

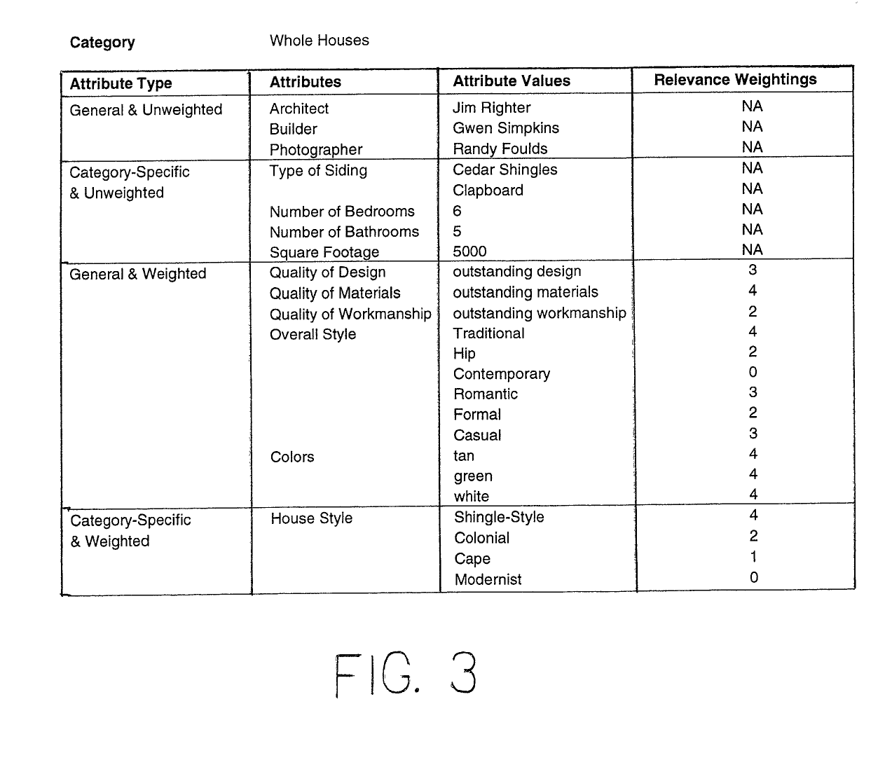

FIG. 3 is an example data record for a particular house. The house falls under the category of “whole houses.” The general and unweighted attributes include the architect, the builder; and the photographer. The category-specific and unweighted attributes include the type of siding, the number of bedrooms, the number of bathrooms, and the square-footage. The attributes that general and relevance weighted include quality of design, quality of materials, quality of workmanship, overall style, and colors. The category- specific and relevance weighted attributes include house style. Certain attributes may have a plurality of values, such as the type of siding attribute and the overall style attribute.

Each attribute value under the relevance weighted attributes has an associated relevance weighting. The relevance weighting indicates the degree to which the attribute applies to the item in the record. For example, the house style attribute under the category-specific and weighted attribute type, has four values, Shingle-Style, Colonial, Cape, Modernist. The relevance weight of the value Shingle-Style is “4” meaning that this value is highly relevant to the description of the house. The relevance weight of the attribute value Colonial is “2” meaning that the descriptor applies but is only somewhat relevant to the description of the house. The relevance weight of the attribute value Cape is “1” meaning that this descriptor is only slightly relevant to the house. The relevance weight of the attribute value Modernist is “0” meaning that this descriptor has no relevance to this house.

The relevance-weighted attribute architecture makes it possible for users to search among items in ways that are more precise and useful than is possible with databases that simply treat attributes as true or false. Using the relevance weights, attribute values are applied to a database item to varying degrees in order to enrich the description of the item and thereby make that item more searchable in the database.

Searching

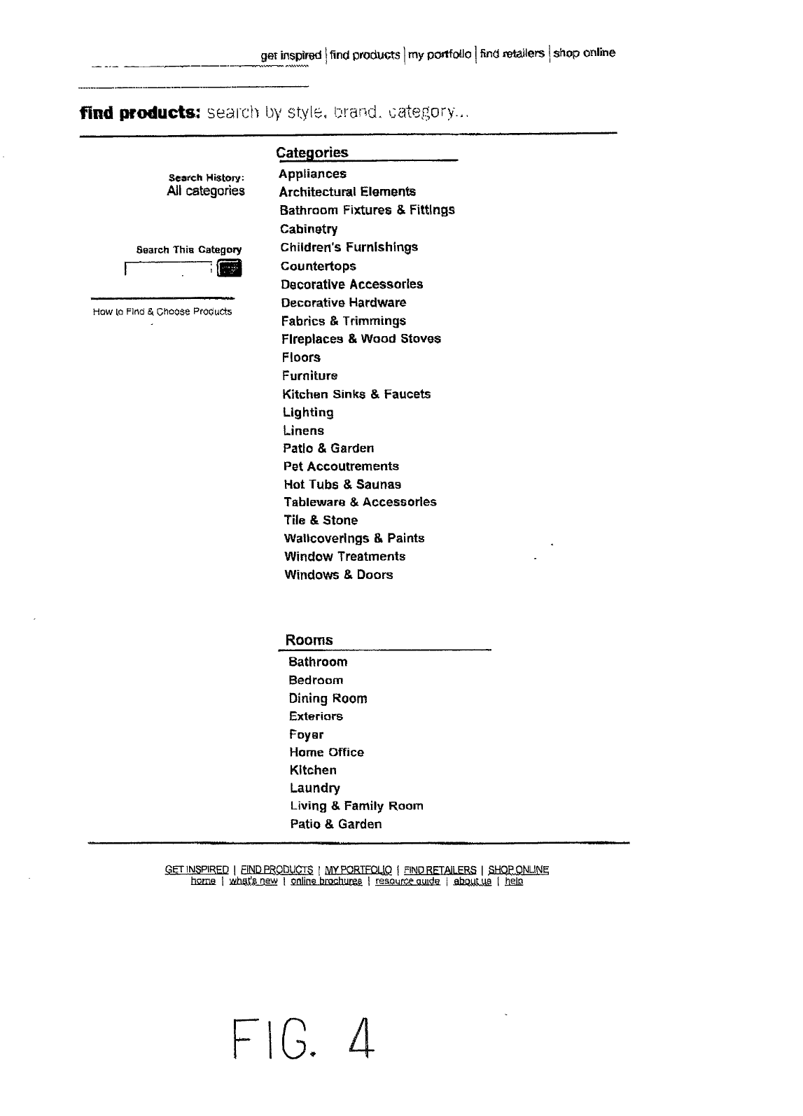

To find a product in the system, the user first selects a category. FIG. 4 is a screen shot of an introductory screen showing a list of categories according to principles of the invention. The categories list includes categories such as appliances and bathroom fixtures and fittings. A further list under categories is the “Rooms” list including such categories as bathroom and home office. The user selects a category of interest.

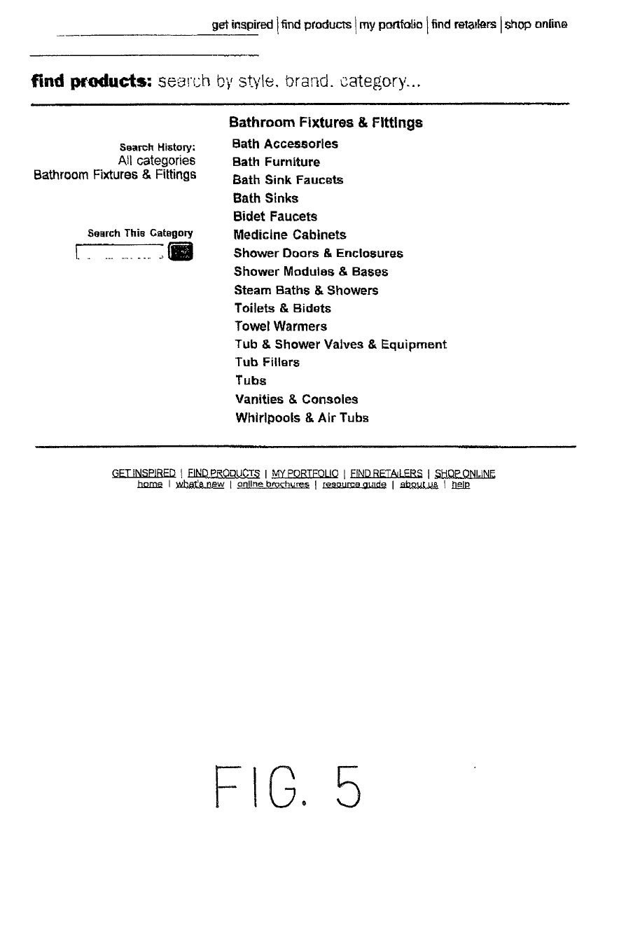

FIG. 5 is a screen shot of the category of bathroom fixtures and fittings selected from the list of FIG. 4. The user browses a selected category until a product of interest is found. The list under bathroom fixtures includes subcategories such as bath accessories and tubs.

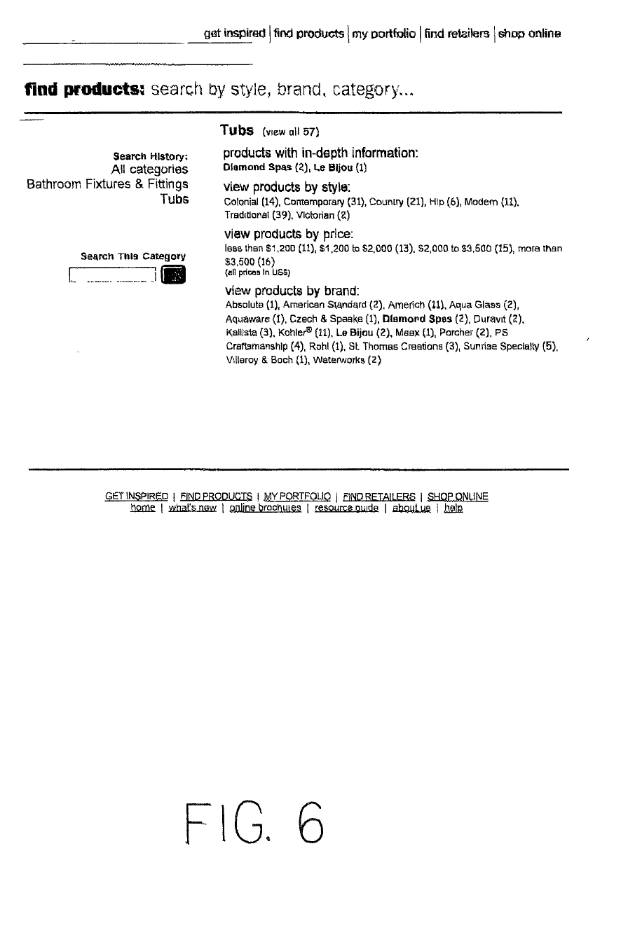

FIG. 6 is a screen shot of the tubs subcategory selected from the list of FIG. 5. This figure shows groups of attributes that apply to the data items under the tubs subcategory. The attributes are presented to the user in predetermined groups based on assumptions of what users might be interested in. The user selects an attribute, in this case, an attribute under groupings of style, price, or brand.

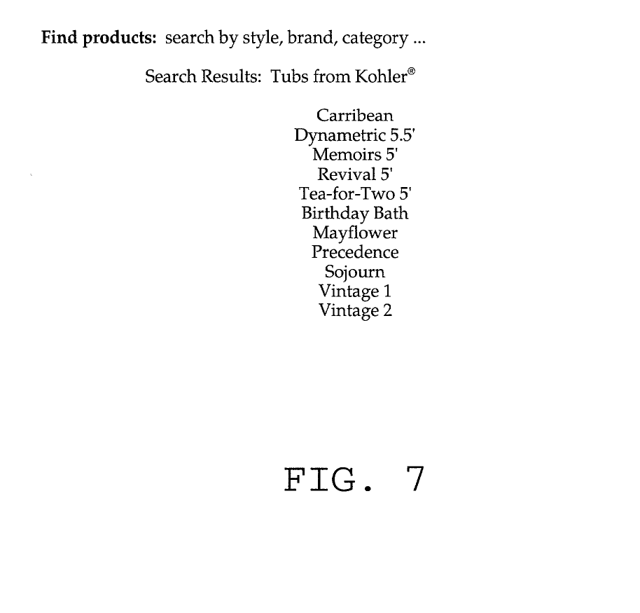

FIG. 7 is a list of the tubs subcategory having the attribute “Kohler” from the list of FIG. 6, the brand Kohler having been selected by the user. The results of the attribute choice are the list of available tubs from the manufacturer Kohler. The user may now choose a specific item from the database.

In a simple search, such as the above search on a single attribute, the system presents all items in the database having that attribute, but those having the highest relevance weights are listed first and then the rest of the items are listed in descending order by relevance weight. For example, if a user is searching for items that are of the style “Arts & Crafts,” those items which are the most “Arts & Crafts” are displayed first on the list of items. The attribute value “Kohler” chosen above, has no relevance weight and so the resulting list is merely the list of all tub items in the database having that brand.

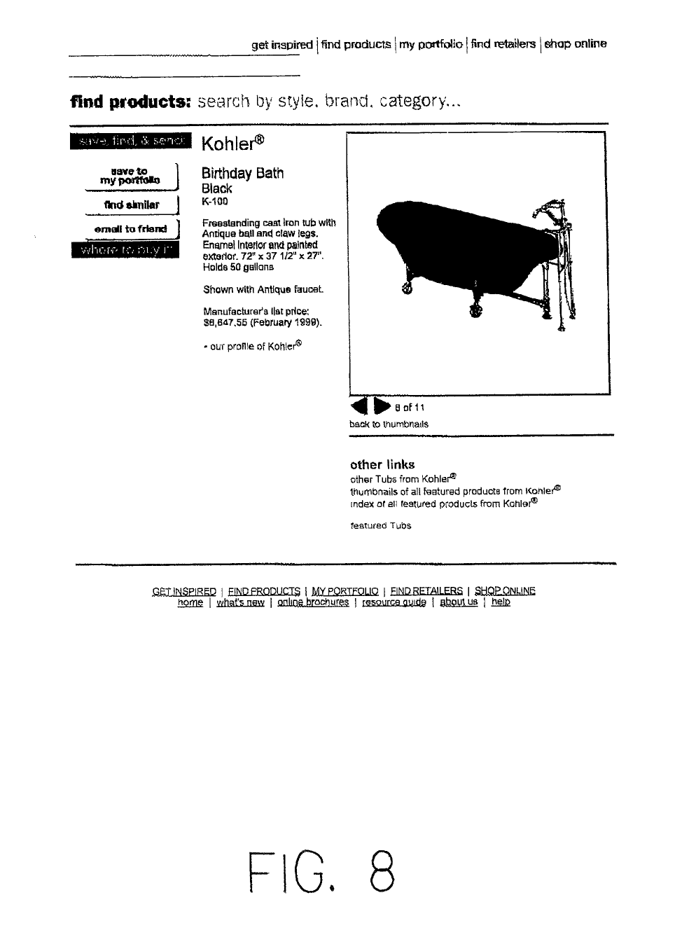

FIG. 8 is a screen shot of a tub item selected from the list of FIG. 7, the Kohler Birthday Bath. A photograph of the item is accompanied by a description. In the database, the elements of the description are stored as attributes and values as illustrated above in FIGS. 2 and 3. The values of relevance weighted attributes are assigned relevance weights at the time the item is entered into the database. Also, shown in FIG. 8 are the options of saving this item to the user's personal portfolio and the “Find Similar” search which will be described below. To keep the user interface simple, many of the attributes are not normally displayed and are used only for “Find Similar” calculations and other advanced searching. Relevance weights, must match check boxes, and importance weights (described below) may be used to calculate which attributes may be exposed on the user interface. For example, the three most noteworthy attributes of a product or a ranked list of the most noteworthy attributes of a particular product may be exposed on the user interface.

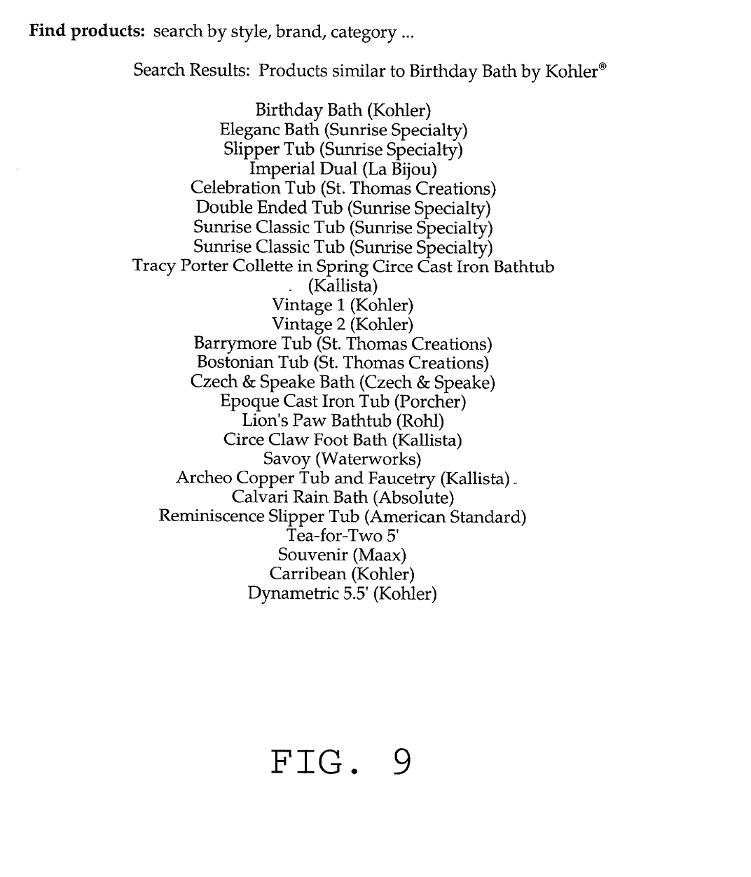

The user may perform a “Find Similar” search in order to find other products having qualities like the product the user has already found. FIG. 9 shows the results of a “Find Similar” search on the Kohler tub of FIG. 8. The results are a selection of tubs having similar appearance and other characteristics.

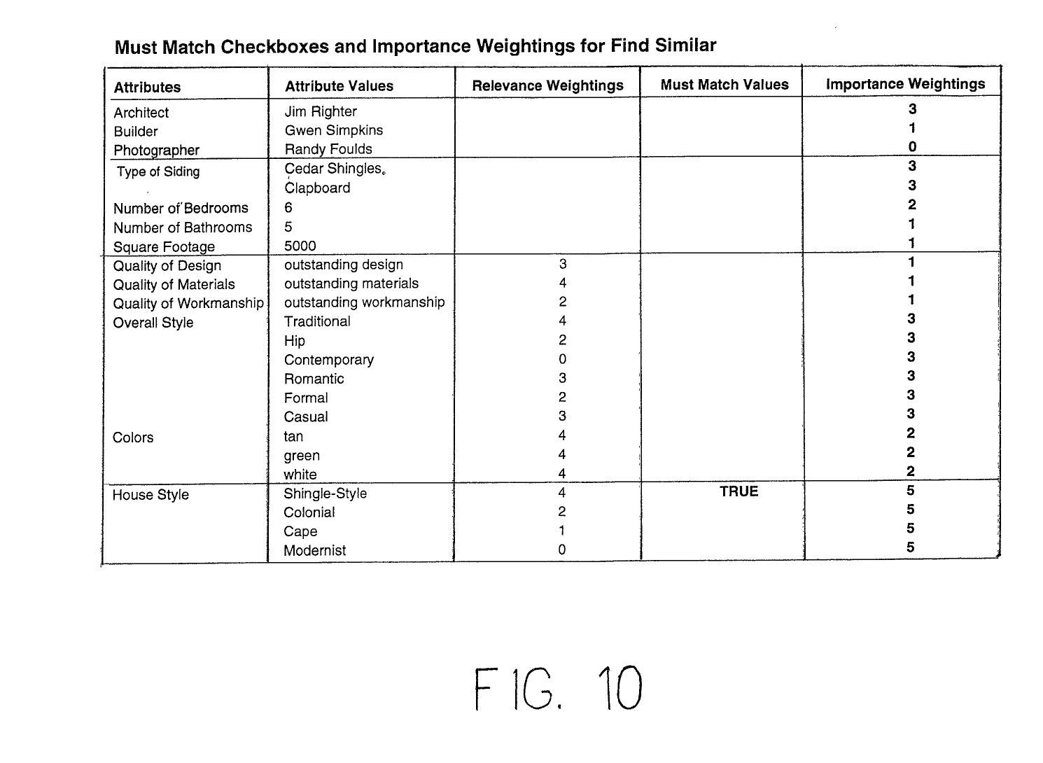

To accomplish more precise “Find Similar” results, the system has must match attributes as shown in FIG. 10. FIG. 10 uses the house example of FIG. 3. “Must match” attributes define which attribute must have values that match exactly in order to be shown in “Find Similar” search results. “Find Similar” results are based on overall similarity, rather than just on similarity to a particular attribute or to a combination of attributes.

A relative “importance” weighting is assigned to each attribute. These importance weightings are typically assigned using a numerical scale (such as, on a scale of blank, where “blank” means a zero weighting, and 1 to 5, where 1 means normal or no extra importance and 5 is 5 times as important as a 1), but could be applied using a variety of metrics.

The importance weightings are fundamentally different from the relevance weightings used elsewhere in the attribute tagging and matching system. Relevance weightings say how relevant a particular attribute value is for a particular database entry. Importance weightings establish how important that particular attribute should be for calculations of similarity.

The importance weightings are used to tune search results. For example, the dresser style attribute value “Chippendale” might be given a weighting of 5 and the leg style attribute value “claw-and-ball” might be given a normal weighting of 1. In this case the importance of attribute differences would be five times as great for dresser style as it would be for leg style.

“Must match” check boxes and importance weightings are first established as defaults for each database category. Then, for each product, these default “must match” checkboxes and importance weightings may be overridden by the user, if desired, in order to tune the results of a “Find Similar” search.

For example, normally the material a faucet is made of is not as important as its finish. If the material, however, is 24-carat gold, its importance to the order of search results is likely to be dramatically greater and might merit a weighting of as much as 5.

Use of must match check boxes and importance weightings enables the system to accommodate important distinctions both at the level of general business rules and at the level of individual products.

The “Find Similar” search uses similarity of database items to produce search results using the method below. Values and weights are referenced in the database as follows: item[i].attribute[j].value[k] for an attribute value without a relevance weight;

item[i].attribute[j].value[k].relevance for an attribute value with a relevance weight;

item[i].attribute[j].mustmatch for a must match attribute; and

item[i].attribute[j].importance for an attribute having an importance value.

In a similarity search, must match serves as a “go/no go” gate, in which the attribute values must match.

A similarity metric is calculated for all remaining attributes that have non-zero importance weightings.

Attributes with importance weightings of blank (or zero) are ignored.

The similarity algorithm for unweighted attributes is as follows:

Let Sₘₙ represent the metric of similarity between item[m] and item[n] where

$${S}_{mn} = {\sum }_{j} Attr Im {p}_{mj} \cdot {AttrValSim}_{mnj}$$

where AttrImpₘⱼ is the scaled measure of importance of the jth attribute of item m and

AttrImpₘⱼ=(item[m] .attribute[j] .importance)^{x} for any x>0

and where AttrValSimₘₙⱼ is the measure of similarities of values of a given attribute and

AttrValSimₘₙⱼ=

$${AttrValSim}_{mnj} = {\sum }_{k} {\sum }_{l} {S}_{{attr}_{j}} ( {value}_{mjk} , {value}_{njl} )$$

where valueₘⱼₖ=item[m].attribute[j].value[k],

where valueₙⱼₗ=item[n].attribute[j].value[l],

and where

S_{attr[j]} is any metric of similarity between all possible values of attribute j, e.g. S_{attr[j]} (a,b) equals 1 if a=b, 0 otherwise.

For weighted attributes, the similarity algorithm is as follows:

Sₐₜₜᵣ_{ⱼ}(a,b)=1−|a.weight−b.weight|

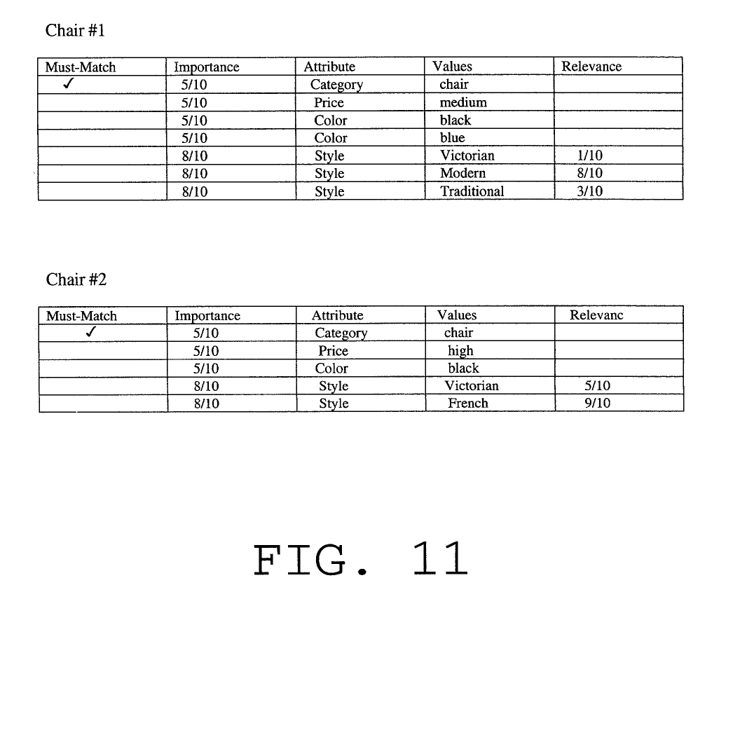

The “find similar” process operates as follows. FIG. 11 has table of attributes and values of a source item and a table of attributes and values of a target time to be used to illustrate the find similar process. Chair #1 is a source data item and Chair #2 is a target data item. Each table has a must-match column, an importance column, an attribute column, a values column, and a relevance column. Importance and relevance weights are presented as an integer value over ten. Relevance weights in this example apply only to attribute “style.” Chair #1 has one must-match attribute which the category.

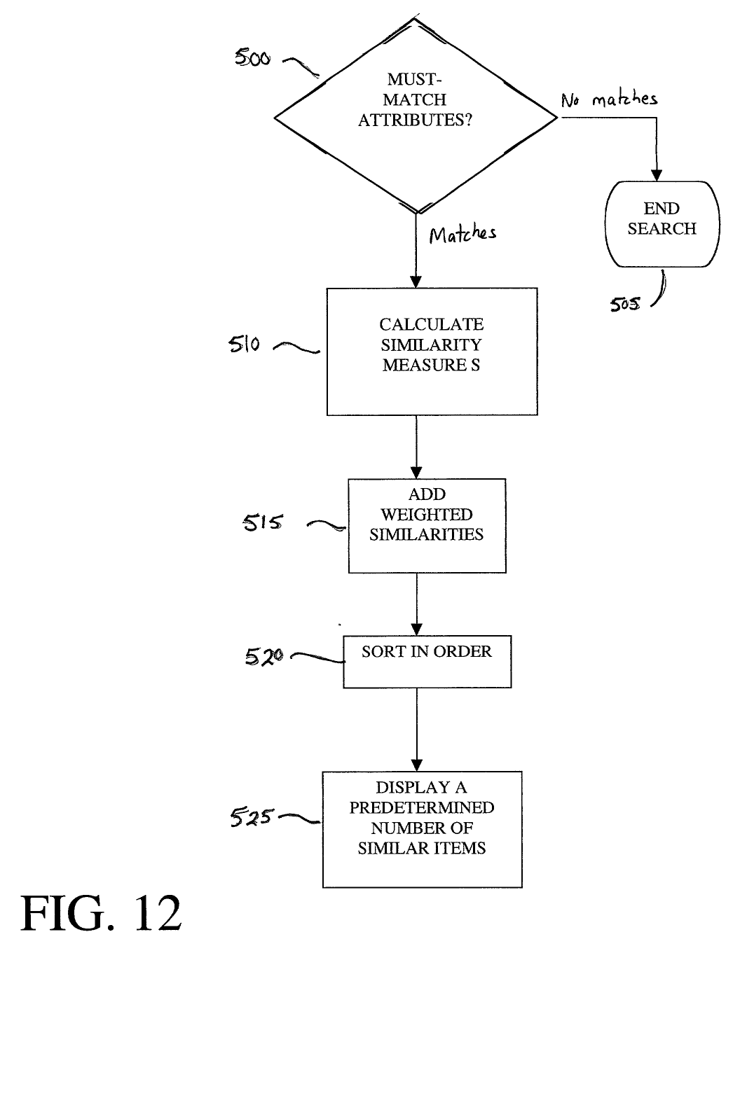

FIG. 12 is a flow chart of the find similar process. The system takes as input a source object having at least one non-trivial or non-null value for an attribute and searches for similar data items using the attributes, values, and weights of the source object. If the source object has any must-match attributes, the system searches the database for matches of those attributes first, block 500. If no matches are found, the search ends, block 505.

If matches for the must-match attributes are found, the system calculates similarity measures, block 510. In the present embodiment of the invention, similarity is calculated as follows using the unweighted similarity algorithm for the unweighted values and the weighted similarity algorithm for the weighted values:

| Attributes | Similarity no. |
|---|---|
| Category chair matches | 1 |
| Price does not match | 0 |
| Color black matches | 1 |
| Color blue does not match | 0 |
| Style Victorian matches to a degree | |

$$1 - ‖ \frac{1}{10} - \frac{5}{10} ‖ = 6 / 10$$

Style Modern is not present in target

$$1 - ‖ \frac{8}{10} - \frac{0}{10} ‖ = 2 / 10$$

Style Traditional is not present in target

$$1 - ‖ \frac{3}{10} - \frac{0}{10} ‖ = 7 / 10$$

Style French is not present in source

$$1 - ‖ \frac{10}{10} - \frac{9}{10} ‖ = 1 / 10$$

Similarity values are calculated for all attributes even where the values are blank or zero. The results may need to be normalized under some circumstances.

The similarity values for attributes are multiplied by the importance weights.

| Attribute | Similarity × Importance |
|---|---|
| Category chair | (1) (5/10) = 0.50 |
| Price | (0) (5/10) = 0.00 |
| Color black | (1) (5/10) = 0.50 |
| Color blue | (0) (5/10) = 0.00 |
| Style Victorian | (6/10) (8/10) = 0.48 |
| Style Modern | (2/10) (8/10) = 0.16 |
| Style Traditional | (7/10) (8/10) = 0.56 |
| Style French | (1/10) (8/10) = 0.08 |
| Total = | 2.28 |

The results of the weighted similarities are added to yield the overall similarity value, block 515. In the present embodiment of the invention the similarities are generally converted to percentages. This is done by finding the similarity value an object has to itself and using that value as a divisor. Using the above-described method, similarities are calculated for each item found in the must-match search. The list of items is the sorted by degree of similarity, block 520.

The list of similar items is then displayed to the user, block 525. If there are many similar items, only a predetermined number of matches are displayed to the user, for example, the ten most similar chairs.

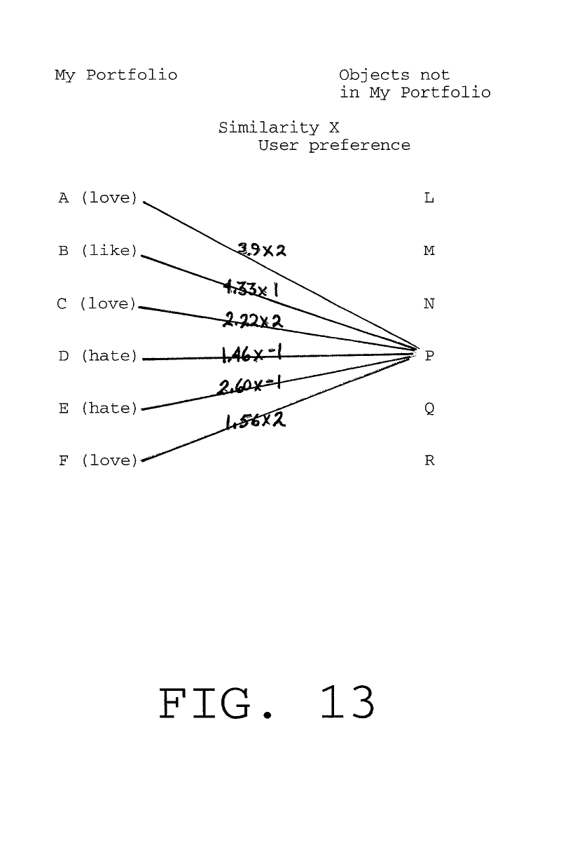

An alternative method of determining similarity is first calculating the Euclidean distance between source and target points for each attribute. For each target and potential source item having n attributes, all n attributes and values are mapped into n-space. The similarity is the inverse distance between the mapped points. 70 The user portfolio provides further enhancement to the searching capabilities of the database. FIG. 13 is a diagram of objects saved to a My Portfolio file mapped to an object in the database that is not in the My Portfolio file. The user has qualified each object in the My Portfolio file with the additional attribute of user preference and the values of “Love”, “Like”, or “Hate”. These values are given numerical values of 2, 1 and −1 respectively. When a “Find Similar” search is performed on objects similar to those in the My Portfolio file, the similarity values are further refined using the user preference attribute values. For example, if object P is being examined for similarity, the similarities between P and the objects in the My Portfolio folder are multiplied by the user preference value. The results are added together to give the similarity value of P according to the preferences of the particular user. In this way, the My Portfolio folder is used to refine the search of the database.

It is to be understood that the above-described embodiments are simply illustrative of the principles of the invention. Various and other modifications and changes may be made by those skilled in the art which will embody the principles of the invention and fall within the spirit and scope thereof.

What is claimed is:

1. A database management system, comprising:
a storage system wherein a plurality of data items, each having a plurality of associated attributes, each is linked logically to stored values for each of said associated attributes and to a weight for at least one of said associated attributes; and
a search system that, given a first data item having at least one non-trivial value for one of said plurality of associated attributes, identifies among said plurality of data items in said storage system, a second data item having attributes, values and weights similar to those of said first data item.

2. A database management system, comprising:
a storage system having a data structure to store data items having a plurality of associated attributes, each of said plurality of associated attributes having a value, at least one selected attribute of said plurality having a weight; and
a search system to search the database for a target data item having similar attributes, values and weights as a source data item.

3. The database management system of claim 2 wherein said attributes further comprise a general attribute type and a specific attribute type.

4. The database management system of claim 2 wherein said attributes further comprise general and unweighted attributes, category-specific and unweighted attributes, general and weighted attributes, and category-specific and weighted attributes.

5. The database management system of claim 4 wherein said attributes further comprise at least one must-match attribute.

6. The database management system of claim 2 wherein at least one attribute has a plurality of values.

7. A method of managing a database, comprising the steps of:
storing data items in the database;
associating a plurality of attributes with each data item, each attribute having at least one value;
providing a weight for at least one selected attribute;
receiving a search request having a plurality of search attributes, each said search attribute having at least one value and at least one attribute having a weight; and
searching the database in response to said request using said plurality of search attributes to find data items matching said search attributes.

8. The method of claim 7 wherein said searching step further comprises searching the database in response to said request using said plurality of search attributes to find data items having attributes similar to said search attributes.

9. The method of claim 8 further comprising the steps of:
receiving at least one must-match attribute in said search request; and
searching the database in response to said request using said plurality of search attributes to find data items matching said at least one must-match attribute; and
if data items matching said at least one must-match attribute are found, searching the database using the remaining search attributes to find similar data items; and
if no data items matching said at least one must-match attribute are found, ending the search.

10. The method of claim 8 further comprising the steps of:
receiving at least one importance weight associated with an attribute in said search request; and
searching the database in response to said request using said plurality of search attributes and said at least one importance weight to find data items having similar attributes to said search attributes.
